(19) United States
(12) Patent Application Publication
(10) Pub. No.: US 2010/0318577 A1
(43) Pub. Date: Dec. 16, 2010

(54) OPERATION OF P2P TELECOMMUNICATIONS NETWORKS

(76) Inventors: Gonzalo Camarillo, Helsinki (FI); Jani Hautakorpi, Masala (FI)

Correspondence Address: ERICSSON INC., 6300 LEGACY DRIVE, M/S EVR 1-C-11, PLANO, TX, 75024, US

(21) Appl. No.: 12/743,967

(22) PCT Filed: Nov. 20, 2007
(86) PCT No.: PCT/EP07/62557

§ 371 Date: May 20, 2010

(51) Int. Cl. G06F 15/16; G06F 17/30

(52) U.S. Cl. 707/802; 709/227; 709/204; 707/E17.032

(57) ABSTRACT

A method of operating a P2PSIP network is described. A resource record is created for a user in the network. A reachability script, which expresses a reachability profile of the user's preferences, is inserted into the resource record. The resource record is uploaded into the network. When an attempt is made to initiate a session with a user, the reachability script is executed so that the correct node may be contacted.

### TECHNICAL FIELD

The present invention relates to the operation of a peer-to-peer network, for example a Universal Mobile Telecommunications System having an IP Multimedia Subsystem. In particular, the invention relates to the operation of Peer-to-Peer Session Initiation Protocol networks.

### BACKGROUND

IP Multimedia services provide a dynamic combination of voice, video, messaging, data, etc. within the same session. By growing the number of basic applications and the media which it is possible to combine, the number of services offered to the end users will grow, and the inter-personal communication experience will be enriched. This will lead to a new generation of personalised, rich multimedia communication services, including so-called “combinational IP Multimedia” services.

The Universal Mobile Telecommunications System (UMTS) is a third generation wireless system designed to provide higher data rates and enhanced services to subscribers. UMTS is a successor to the Global System for Mobile Communications (GSM), with an important evolutionary step between GSM and UMTS being the General Packet Radio Service (GPRS). GPRS introduces packet switching into the GSM core network and allows direct access to packet data networks (PDNs). This enables high-data rate packets switch transmissions well beyond the 64 kbps limit of ISDN through the GSM call network, which is a necessity for UMTS data transmission rates of up to 2 Mbps. UMTS is standardised by the 3^{rd} Generation Partnership Project (3GPP) which is a conglomeration of regional standards bodies such as the European Telecommunication Standards Institute (ETSI), the Association of Radio Industry Businesses (ARIB) and others. See 3GPP TS 23.002 for more details.

The UMTS architecture includes a subsystem known as the IP Multimedia Subsystem (IMS) for supporting traditional telephony as well as new IP multimedia services (3GPP TS 22.228, TS 23.228, TS 24.229, TS 29.228, TS 29.229, TS 29.328 and TS 29.329 Releases 5 to 7). IMS provides key features to enrich the end-user person-to-person communication experience through the use of standardised IMS Service Enablers, which facilitate new rich person-to-person (client-to-client) communication services as well as person-to-content (client-to-server) services over IP-based networks. The IMS is able to connect to both PSTN/ISDN (Public Switched Telephone Network/Integrated Services Digital Network) as well as the Internet.

The IMS makes use of the Session Initiation Protocol (SIP) to set up and control calls or sessions between user terminals (or user terminals and application servers). SIP makes it possible for a calling party to establish a packet switched session to a called party (using so-called SIP User Agents, UAs, installed in the user terminals) even though the calling party does not know the current IP address of the called party prior to initiating the call. The Session Description Protocol (SDP), carried by SIP signalling, is used to describe and negotiate the media components of the session. Whilst SIP was created as a user-to-user protocol, IMS allows operators and service providers to control user access to services and to charge users accordingly. The 3GPP has chosen SIP for signalling between a User Equipment (UE) and the IMS as well as between the components within the IMS.

Specific details of the operation of the UMTS communications network and of the various components within such a network can be found from the Technical Specifications for UMTS that are available from http://www.3gpp.org. Further details of the use of SIP within UMTS can be found from the 3GPP Technical Specification TS 24.228 V5.8.0 (2004-03).

As SIP has increased in popularity, situations have arisen where centralised servers are either inconvenient or undesirable. Peer-to-Peer (P2P) systems have emerged as a mechanism for decentralised, server-free implementations of various applications. In P2P architecture, peer nodes cooperate together to perform tasks. By contrast to client-server architecture, each peer has generally equal importance and performs the same tasks within the network. Additionally, peers communicate directly with one another to perform tasks.

In particular, many recent efforts have focussed on applying P2P to SIP, resulting in a technology called Peer-to-Peer Session Initiation Protocol (P2PSIP). This combination reduces, or removes completely, the need for centralized servers, such as the ones used in the IMS, by pushing most, or all, functionality to the end devices. P2PSIP was first proposed in 2005 (K. Singh and H. Schulzrinne, “Peer-to-peer Internet Telephony Using SIP,” in NOSSDAV '05: Proceedings of the international workshop on Network and operating systems support for digital audio and video. New York, N.Y., USA: ACM Press, 2005, pp. 63-68).

Although it is possible to build isolated P2PSIP networks, it is expected that many will be connected in some way to existing SIP-based networks (such as IMS). This way, IMS users and P2PSIP users will be able to communicate seamlessly.

A fundamental problem with P2P applications is the efficient location of the node storing a particular data item, and the location of a node for session initiation. This problem is addressed by Distributed Hash Table (DHT) algorithms such as Chord (as described, for example, by R. Stoica et al., “Chord: A Scalable Peer-to-peer Lookup Service for Internet Applications,” in Proceedings of the ACM SIGCOMM '01 Conference, San Diego, Calif., August 2001, pp. 149), and the emergence of such algorithms has been instrumental in the development of P2PSIP.

It is intended that P2PSIP technology will be standardized in the Internet Engineering Task Force (IETF). There have been numerous unofficial P2PSIP meetings in the past, but in the IETF meeting of March 2007, a P2PSIP working group was officially chartered and met for the first time. Despite the fact that it was the first official meeting, many drafts were already in existence. Examples of these include D. Bryan et al., “dSIP: A P2P Approach to SIP Registration and Resource Location”, draft-bryan-p2psip-dsip-00, IETF, February 25, 2007, Work-in-progress; D. Bryan et al., “Concepts and Terminology for Peer to Peer SIP”, draft-willis-p2psip-concepts-04, IETF, March 4, 2007, Work-in-progress; E. Cooper et al., “NAT Traversal for dSIP”, draft-matthews-p2psip-dsip-nat-traversal-00, IETF, February 25, 2007, Work-in-progress; X. Jiang, “The requirement of P2PSIP Peer protocol”, draft-jiang-p2psip-peer-protocol-requirement-00.txt, IETF, February 1, 2007, Work-in-progress; M. Zangrilli and D. Bryan, “A Chord-based DHT for Resource Lookup in P2PSIP”, draft-zangrilli-p2psip-dsip-dhtchord-00, IETF, February 25, 2007, Work-in-progress.

It would be desirable for users of devices within P2PSIP networks to be able to ensure that calls to them are routed to the correct terminal. For example, a user may be preferred to be called on an office telephone during the day, and at his home in the evening. He may also wish to divert calls to his mobile, or to some other terminal.

Current proposals for P2PSIP networks do not include any provision for a service by which callees can ensure that calls are forwarded to their preferred terminal. Networks operating traditional SIP do have this capability, but the mechanisms by which this is implemented are not easily transferrable to P2PSIP networks.

FIG. 1 illustrates a scenario in a traditional SIP network 1 where a callee 2 has two SIP User Agents (UAs) 3, 4 in his domain 5 which contains a SIP proxy 6. A caller 7 has a UA 8 in his domain 9, the caller's domain also having a SIP proxy 10. Suppose the callee can currently be reached at the second of his two UAs 4. The callee creates a “reachability script” 11 for the SIP proxy 6 in his domain 5. In traditional SIP networks the end-customers always use SIP services provided by some Voice over IP (VoIP) service provider, which is often his telecom operator. The VoIP service provider maintains and operates SIP infrastructure and allows end-customers to use it.

The reachability script is typically written in Call Processing Language (CPL), which is described by J. Lennox et al. in “Call Processing Language (CPL): A Language for User Control of Internet Telephony Services”, RFC3880, Internet Engineering Task Force, October 2004. In the scenario presented in FIG. 1, the reachability script could state, for example, “Callee is reachable at UA#2.” The reachability script can also be more complex and could instead state, for example, “Callee can be reached on UA#1 between 8:00 and 16:00 and on UA#2 at other times. If the callee is busy, the call must be redirected to a voicemail service.”

As shown in FIG. 1, when the caller 7 tries to establish a session with the callee 2, the SIP signalling first goes through the SIP proxy 10 in the caller's domain 9, and then reaches the SIP proxy 6 in the callee's domain 5. The SIP proxy 6 in the callee's domain 5 has associated with it the callee's reachability script 11, and by executing the script the proxy 6 knows that the callee 2 can be reached at his second UA 4. So, it forwards the SIP signalling towards the callee's second UA 4 and the session can be established.

In traditional SIP networks the reachability script is executed by the SIP proxy in the callee's domain.

### SUMMARY

In accordance with one aspect of the present invention there is provided a method of operating a decentralised interpersonal communication network. The method comprises creating a resource record for a user in the network. A reachability script, which expresses a reachability profile of the user's preferences, is inserted into the resource record. The resource record is uploaded into the network. The network is preferably a P2PSIP network.

The reachability profile preferably contains data for preferred terminals for contacting the user. This may apply where the user has more than one terminal connected to the network, or where they have subscribed to voicemail. The reachability script may preferably be written in CPL.

The resource record (including the reachability script) is preferably uploaded to a node within the network responsible for maintaining resource records. Resource records are preferably uploaded into the network whenever a user's terminal enters or leaves the network, or whenever the IP address of a user's terminal changes. The resource record may be uploaded into the network using an ASP STORE message, a RELOAD RESOURCE-PUT message or a P2PP Publish message, for example.

In accordance with another aspect of the present invention there is provided a method of initiating a session from a calling node to a called node in a decentralised interpersonal communication network (preferably a P2PSIP network). The method comprises requesting a location of the called node from the network. A reachability script for a user of the called node is executed, the reachability script expressing a reachability profile of the user's preferences. The session is then initiated on the basis of information contained in the reachability profile.

In one embodiment the reachability script is downloaded to the calling node and executed at the calling node. As a result of the execution of the reachability script the calling node may initiate a session with a different called node.

In another embodiment the reachability script is executed by a node within the network responsible for maintaining resource records. In this case, the called node located by the network may be different from that originally requested by the calling node, if the reachability profile requires a different calling node to be contacted.

The initial location request made by the calling node may be mapped to an ASP FETCH message, a RELOAD RESOURCE-GET message or a P2PP LookupObject message, for example.

In accordance with a further aspect of the present invention there is provided a node arranged to join a Peer-to-Peer Session Initiation Protocol network. The node is arranged to create a reachability script which expresses a reachability profile for the user of the node. The node is also arranged to insert the reachability script into a resource record and upload the resource record into the network.

In accordance with a yet further aspect of the present invention there is provided a calling node arranged to initiate a session with a called node in a Peer-to-Peer Session Initiation Protocol network. The calling node is arranged to request a location of the called node from the network and download a reachability script for a user of the called node. The called node is also arranged to execute the reachability script, and initiate the session on the basis of information contained in the reachability script.

In accordance with another aspect of the present invention there is provided a node arranged to maintain resource records in a Peer-to-Peer Session Initiation Protocol network. The node is arranged to receive a resource record from a callee node joining the network, the resource record including a reachability script expressing a reachability profile for a user of the callee node. The node is also arranged to receive a callee node location request from a calling node in the network, and execute the reachability script to identify the correct called node on the basis of the user's reachability profile. The node is also arranged to inform the calling node of the called node's location. Alternatively, instead of executing the reachability script, the node may be arranged to forward the reachability script to the calling node.

### BRIEF DESCRIPTION OF THE DRAWINGS

FIG. 1 is a schematic representation of a traditional SIP network, showing the use of a reachability profile.

FIG. 2 is a schematic representation of a P2PSIP network, illustrating how a callee can place a reachability profile into the network.

FIG. 3 is a schematic representation of the P2PSIP network of FIG. 2, illustrating how a reachability profile can be used to ensure that calls are routed to the correct UA of the callee.

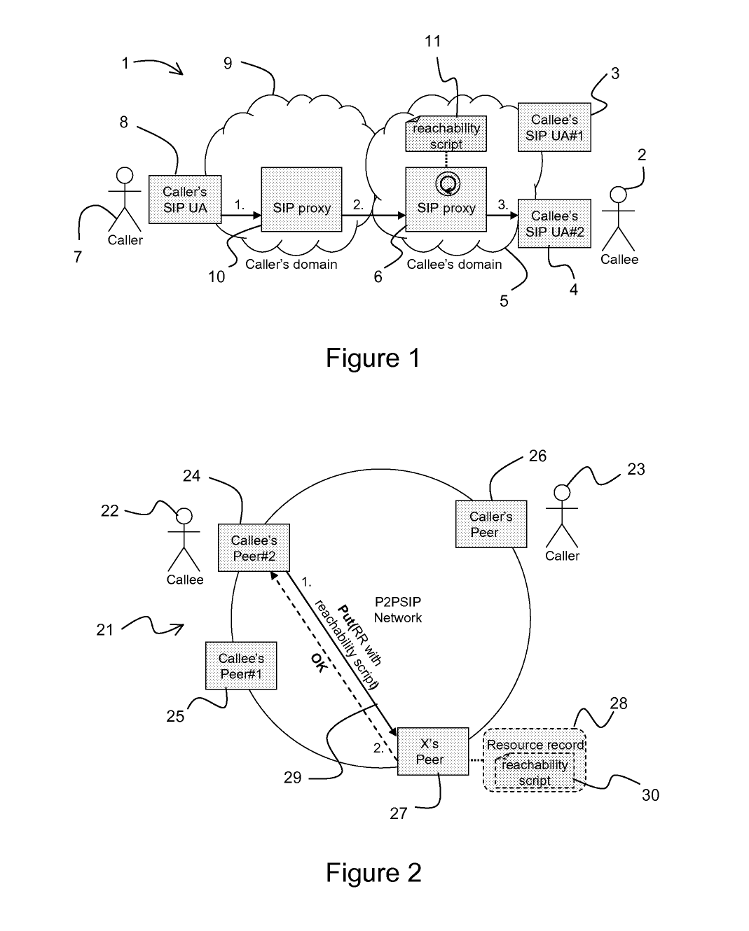

### DETAILED DESCRIPTION

The system required to put the invention into effect is known as Reachability Mechanism for P2PSIP Networks (RMP). The RMP makes it possible for the callee to create his/her own reachability profile in the P2PSIP network. Even though a similar service exists in the traditional SIP network, it is currently not specified for P2PSIP networks.

P2PSIP networks are substantially different to traditional SIP networks, and this difference greatly affects the way in which reachability mechanisms can be implemented. The biggest differences are:
P2PSIP networks do not have SIP proxies; there are only peers that are not operated by a VoIP provider.
P2PSIP networks do not have the concept of “domains” which are present in traditional SIP networks.
P2PSIP networks include the concept of resource records (discussed below).
P2PSIP networks have existing request/reply messages going between the caller and the peer responsible for the resource record. These messages are specified as a part of proposed peer protocols.

Provision has been made within P2PSIP for a “resource record”, as described in D. Bryan et al., “Concepts and Terminology for Peer to Peer SIP”, draft-ietf-p2psip-concepts-00, Internet Engineering Task Force, June 2007. Currently the resource record is specified only at high level, and the exact wording is as follows:
“P2PSIP Resource Record: A block of data, stored using distributed database mechanism of the P2PSIP Overlay, that includes information relevant to a specific resource. We presume that there may be multiple types of resource records. Some may hold data about Users, and others may hold data about Services, and the working group may define other types. The types, usages, and formats of the records are a question for future study.”

In order to store the reachability profile in a P2PSIP network, it is expressed in a reachability script which is included in the callee's resource record. In one embodiment, the reachability script may be written in CPL, as with traditional SIP networks.

The RMP mechanism consists of two phases. In the first phase the callee writes his resource record to the P2PSIP network. When RMP is used, the resource record also contains the reachability script.

FIG. 2 is a schematic representation of a P2PSIP network 21 to which two users are connected—a callee 22 and caller 23. The callee 22 has two UAs (or peers) 24, 25 and the caller has a peer 26. Another user “X” (not shown) also has a peer 27 in the network. When one of the callee's UAs 25 joins the network, a “node id” and “user id” are created by hashing some property of the node, such as its IP address, and some property of the user, such as his SIP Uniform Resource Identifier (URI). A resource record is inserted into the network in a “put” operation and saved at some node (such as, for example, X's peer 27) that maintains such records. The put operation is routed to X's peer 27 by using an overlay routing. The overlay routing is provided, for example, by a Distributed Hash Table (DHT) algorithm. The resource record contains the reachability script 30 for the callee 22.

The put operation 29 is also performed whenever the IP address of any of the callee's UAs 24, 25 changes, or when the reachability profile for the callee needs to be updated. The important functionalities in this phase are the fact that the message implementing put operation is able to contain a reachability script and that the node maintaining resource records (X's peer 27) is able to store the reachability script. Various alternatives are suitable for the put operation. It could be mapped, for example, to the STORE message in ASP as described by C. Jennings et al., “Address Settlement by Peer to Peer (ASP)”, draft-jennings-p2psip-asp-00, Internet Engineering Task Force, July 2007, Work-in-progress. Alternatively, it could be mapped to the RESOURCE-PUT message in RELOAD as described by D. Bryan et al., “REsource LOcation And Discovery (RELOAD)”, draft-bryan-p2psip-reload-01, Internet Engineering Task Force, July 2007, Work-in-progress. A further alternative would be to map it to the Publish message in P2PP as described by S. Baset et al., “Peer-to-Peer Protocol (P2PP)”, draft-baset-p2psip-p2pp-00, Internet Engineering Task Force, July 2007, Work-in-progress.

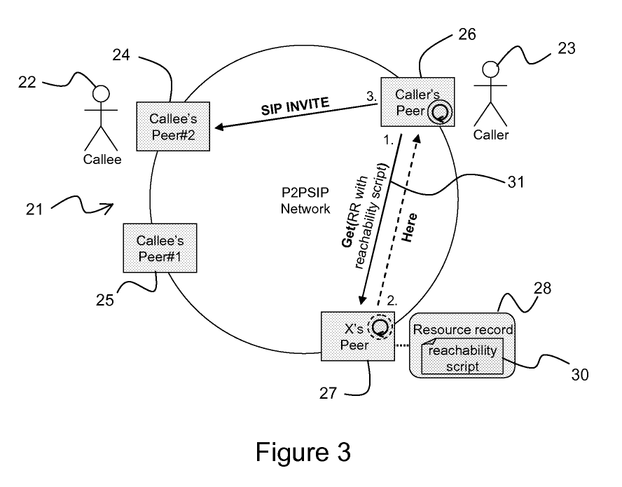

FIG. 3 illustrates the second phase of RMP, in which the caller 23 attempts to establish a session with the callee 22 in the P2PSIP network 21. The caller's UA 26 first performs a get operation 31 which is required in order to obtain the callee's contact address, for example its IP address. The information required is obtained from X's peer 27. The get operation can be mapped, for example, to the FETCH message in ASP, RESOURCE-GET message in RELOAD, or to the LookupObject message in P2PP. Since RMP is being used, X's peer also maintains the resource record for he callee 22, and the caller 23 can therefore also obtain the reachability script of the callee 22.

The reachability script can be executed either on the peer that is responsible for the callee's resource record (X's peer 27) or on the caller's peer 26. If the script is executed at X's peer 27, then the caller 23 does not need to receive the reachability script itself, but is simply provided with the “right” contact address for the callee. In this example this is the contact address of the callee's Peer#2 25.

If the script is executed at the caller's peer 26, then the response to the get operation must include the reachability script. It is therefore important, in the get phase, that the reachability script can be executed on X's peer 27 and on the caller's peer 26, and that the reachability script can be conveyed to the caller's peer 26.

In addition, it is also necessary to maintain reachability scripts: they can be updated or removed from the P2PSIP network 21. Updating can be carried out using the same messages as the put operation described above, although it will be appreciated that different messages could also be used. A “remove” operation can be mapped, for example, to the REMOVE message in ASP, to SIP's REGISTER message in RELOAD, or to the RemoveObject message in P2PP.

Without RMP the users of the P2PSIP network could not create reachability profiles for themselves. The reachability profiles are required especially in cases where users have more than one terminal, or have subscribed to services such as voicemail.

It will be appreciated that variations from the above described embodiments may still fall within the scope of the invention.

Furthermore, the description above refers to P2PSIP networks, but it will be appreciated that it is also applicable to other P2P networks used for interpersonal communication. Other examples include the Internet and corporate networks.

1-17. (canceled)

18. A method of operating a Peer-to-Peer Session Initiation Protocol (P2PSIP) network, comprising the steps of:
creating a P2PSIP resource record for a user in the network;
inserting into the resource record a reachability script, the reachability script expressing a reachability profile of the user's preferences;
uploading the resource record into the network; and,
storing the resource record using a distributed database mechanism of a P2PSIP overlay of the network.

19. The method of claim 1, wherein the reachability profile contains data for preferred terminals for contacting the user.

20. The method of claim 1, wherein the reachability script is written in Call Processing Language.

21. The method of claim 1, wherein the resource record is uploaded to a node within the network responsible for maintaining resource records.

22. The method of claim 1, wherein the resource record is uploaded into the network whenever a user's terminal enters or leaves the network.

23. The method of claim 1, wherein the resource record is uploaded into the network whenever the IP address of a user's terminal changes.

24. The method of claim 1, wherein the resource record is uploaded into the network using an ASP STORE message, a RELOAD RESOURCE-PUT message or a P2PP Publish message.

25. A method of initiating a session from a calling node to a called node in a Peer-to-Peer Session Initiation Protocol (P2PSIP) network, comprising the steps of:
requesting a location of the called node from the network;
downloading a reachability script to the calling node from the network, the reachability script included in a P2PSIP resource record stored using a distributed database mechanism of a P2PSIP overlay of the network and comprising a reachability script for a user of the called node, the reachability script expressing a reachability profile of the user's preferences;
executing the reachability script at the calling node; and,
initiating the session on the basis of information contained in the reachability profile.

26. The method of claim 8, wherein the calling node initiates a session with a different called node as a result of the execution of the reachability script.

27. The method of claim 8, wherein the location of the called node is requested from the network using an ASP FETCH message, a RELOAD RESOURCE-GET message or a P2PP LookupObject message.

28. A node arranged to join a Peer-to-Peer Session Initiation Protocol (P2PSIP) network, wherein the node is operative to:
create a reachability script, the reachability script expressing a reachability profile for the user of the node;
insert the reachability script into a P2PSIP resource record; and,
upload the resource record into the network.

29. A calling node arranged to initiate a session with a called node in a Peer-to-Peer Session Initiation Protocol (P2PSIP) network, wherein the node is operative to:
request a location of the called node from the network;
download a P2PSIP resource record from the network, the resource record comprising a reachability script for a user of the called node;
execute the reachability script; and,
initiate the session on the basis of information contained in the reachability script.

30. A node arranged to maintain resource records in a Peer-to-Peer Session Initiation Protocol (P2PSIP) network, the node operative to:
receive a P2PSIP resource record from a callee node joining the network, the resource record including a reachability script expressing a reachability profile for a user of the callee node;
receive a callee node location request from a calling node in the network; andm
forward the reachability script to the calling node.
